(19) United States
(12) Patent Application Publication
(10) Pub. No.: US 2026/0188174 A1
(43) Pub. Date: Jul. 2, 2026

(54) IMAGE PROCESSING METHOD, COMPUTER READABLE RECORDING MEDIA, AND ELECTRONIC APPARATUS

(71) Applicant: Novatek Microelectronics Corp., Hsinchu (TW)

(72) Inventors: Hsin-Han Lu, Taoyuan City (TW); Yen-Tao Liao, Hsinchu City (TW)

(73) Assignee: Novatek Microelectronics Corp., Hsinchu (TW)

(21) Appl. No.: 19/291,541

(22) Filed: Aug. 5, 2025

Related U.S. Application Data
(60) Provisional application No. 63/741,127, filed on Jan. 2, 2025.

(30) Foreign Application Priority Data
May 28, 2025 (TW) 114119993

(51) Int. Cl. G09G 3/20; G06T 5/40; G06T 5/73; G06V 10/25; G06V 40/10

(52) U.S. Cl. CPC G09G 3/2092; G06T 5/40; G06T 5/73; G06V 10/25; G06V 40/10; G06T 2207/20021; G06T 2207/30196; G09G 2320/064; G09G 2320/066; G09G 2330/021

(57) ABSTRACT

Provided is an image processing method adapted to adjust a contrast and a brightness of an image. The image processing method includes: an image data of the image is extracted; the brightness of the image is adjusted based on the extracted image data; and the contrast of the image is adjusted based on the adjusted brightness of the image.

### CROSS-REFERENCE TO RELATED APPLICATION

This application claims the priority benefit of U.S. provisional application Ser. No. 63/741,127, filed on Jan. 2, 2025 and Taiwan application serial no. 114119993, filed on May 28, 2025. The entirety of each of the above-mentioned patent applications is hereby incorporated by reference herein and made a part of this specification.

### BACKGROUND

### Technical Field

The disclosure relates to a data processing method, a computer readable recording media and an electronic apparatus, and particularly relates to an image processing method, a computer readable recording media and an electronic apparatus.

### Related Art

In related technology, power saving is generally achieved through technical means of reducing a brightness of a light source module or dimming an image data. However, this manner may only adjust an overall brightness of an image screen to be brighter or darker. In this way, the image screen may usually lose details with an overall compensation, sacrificing image quality.

### SUMMARY

The disclosure provides an image processing method, a computer readable recording media and an electronic apparatus, in which the image processing method can enhance image quality in a power-saving condition.

The image processing method of the embodiment of the disclosure is adapted to adjust a contrast and a brightness of an image. The image processing method includes: an image data of an image is extracted; the brightness of the image is adjusted based on the extracted image data; and the contrast of the image is adjusted based on the adjusted brightness of the image.

The computer readable recording media of the embodiment of the disclosure includes a computer program, which commands a computer to execute the foregoing image processing method after executing the computer program.

The electronic apparatus of the embodiment of the disclosure includes a processor and a storage element. The storage element stores a computer program, which commands the processor to execute the foregoing image processing method after executing the computer program.

In order to make the features and advantages of the disclosure more comprehensible, the following examples are given and described in detail with the accompanying drawings as follows.

### BRIEF DESCRIPTION OF THE DRAWINGS

FIG. 1 is a block diagram of a display apparatus according to an embodiment of the disclosure.

FIG. 2 is an outline diagram of a weight map configured for image processing according to an embodiment of the disclosure.

FIG. 3 is a block diagram of an image processing module according to an embodiment of the disclosure.

FIG. 4 is an outline diagram of a weight map configured for image processing according to another embodiment of the disclosure.

FIG. 5A is an original image before being processed using an image processing module according to an embodiment of the disclosure.

FIG. 5B is an output image after being processed using an image processing module according to an embodiment of the disclosure.

FIG. 6 is a block diagram of an image processing module according to another embodiment of the disclosure.

FIG. 7A is an original image before being processed using an image processing module according to another embodiment of the disclosure.

FIG. 7B is an output image after being processed using an image processing module according to another embodiment of the disclosure.

FIG. 7C is a pixel histogram obtained by analyzing an original image using an image processing module.

FIG. 7D is an outline diagram of various gamma curves according to an embodiment of the disclosure.

FIG. 8A is an original image before being processed using an image processing module according to another embodiment of the disclosure.

FIG. 8B is an output image after being processed using an image processing module according to another embodiment of the disclosure.

FIG. 9 is an outline diagram of a method of generating a weight map according to an embodiment of the disclosure.

FIG. 10A and FIG. 10B are outline diagrams of an image processing module respectively using different weight maps to perform contrast enhancement on an original image according to an embodiment of the disclosure.

FIG. 11 is an outline diagram of a data extraction module performing data extraction according to an embodiment of the disclosure.

FIG. 12A, FIG. 12B, FIG. 12C and FIG. 12D are respectively outline diagrams of a data extraction module performing adjustment on a pixel histogram.

FIG. 13A, FIG. 13B and FIG. 13C are respectively outline diagrams of multiple gamma curves.

FIG. 14 is a block diagram of an electronic apparatus according to an embodiment of the disclosure.

FIG. 15 is a flowchart of steps of an image processing method according to an embodiment of the disclosure.

### DESCRIPTION OF THE EMBODIMENTS

The term “coupling (or connection)” used in the full text of the specification of the disclosure (including the claims) may refer to any direct or indirect means of connection. For example, if the text describes that a first apparatus is coupled (or connected) to a second apparatus, it should be interpreted as that the first apparatus may be directly connected to the second apparatus, or the first apparatus may be indirectly connected to the second apparatus through other apparatuses or some kind of connection means. The terms “first” and “second” mentioned in the entire specification of the disclosure (including claims) are used to name the elements, or to distinguish between different embodiments or ranges, and are not used to limit the upper or lower limit of the number of elements, nor are they used to limit the order of the components. In addition, wherever possible, elements/components/steps using the same reference numbers in the drawings and embodiments represent the same or similar elements/components/steps. Elements/components/steps that use the same reference numerals or use the same terms in different embodiments may be cross-referenced for relevant descriptions.

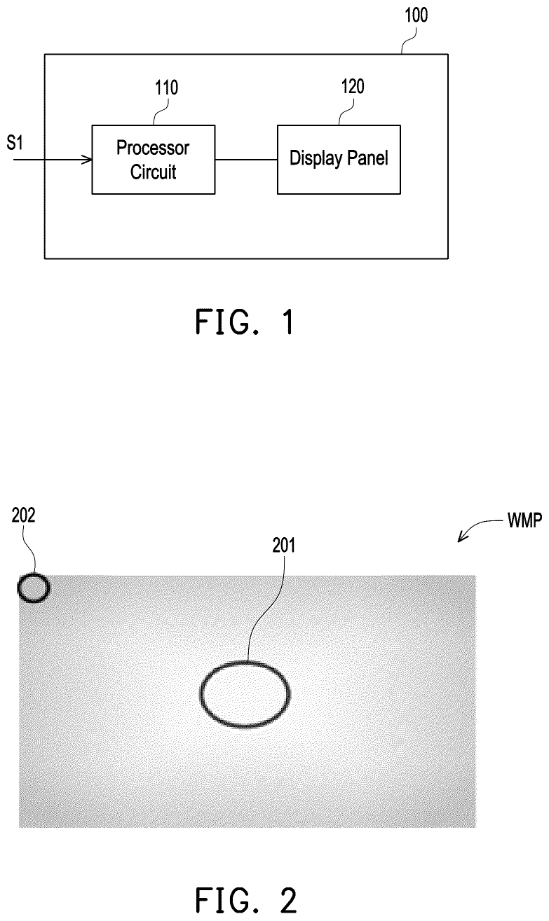

FIG. 1 is a block diagram of a display apparatus according to an embodiment of the disclosure. Please refer to FIG. 1. A display apparatus 100 includes a processor circuit 110 and a display panel 120. The processor circuit 110 is coupled to the display panel 120. The processor circuit 110 is configured to perform an image processing operation on an input image signal S1, and accordingly control and drive the display panel 120 to display an image screen. The image signal S1 is a RGB signal or a YUV signal, which is provided by a previous image processing module or a front-end system.

In the art of contrast enhancement, adapted dimming solution (ADS) and contrast enhancement (CE) technology each have their own advantages. ADS reduces pixels or light sources around a screen by taking advantage of a habit that human eyes tend to focus on the center of the screen, thereby achieving the power-saving effect. CE enhances human eye comfort through global CE and local CE.

In the art of power-saving, LCD panels are often used in conjunction to reduce light sources and compensate image data to achieve power saving. For OLED, power saving is achieved by a manner of dimming image data.

In the embodiment, the processor circuit 110 may combine ADS and CE image processing operations to perform processing on the image signal S1, and accordingly control and drive the display panel 120 to display the image screen to enhance display quality. Specifically, the processor circuit 110, through the ADS image processing operation, recognizes a most attractive region in the screen according to a screen content, and calculates a weight map (WMP) as shown in FIG. 2. The darker the weight map, the less attention-drawing, and the smaller the weight value, which may allow a pixel brightness of a processed image to be darker. For example, in FIG. 2, a region 201 is a region with less brightness reduction, and a region 202 is a region with more brightness reduction.

On the other hand, in order to display images that may rival real-world scenes on the panel, CE technology is frequently used to enhance image quality. Therefore, the processor circuit 110 further performs the CE image processing operation on the image signal S1. The processor circuit 110 performs partitioned processing on the image signal S1 through information from the weight map, enhancing details in a region with reduced brightness. Taking local CE as an example, in the region 201, since a magnitude of brightness reduction is not significant, the processor circuit 110 may apply a default local CE intensity. In the region 202, since a magnitude of brightness reduction is greater, which may lead to loss of details, the processor circuit 110 may increase an intensity of local CE to reserve and enhance the details in the region.

Therefore, in order to maintain an original image quality even when the brightness is dimmed, the processor circuit 110 may obtain a region to be enhanced and a corresponding intensity when performing local CE through the weight map information obtained from ADS. That is to say, the processor circuit 110 combines light source control and contrast enhancement, achieving the power-saving effect by controlling a duty cycle of the light source. In this way, the processor circuit 110 may enhance the image quality of the display apparatus 100 in a power saving condition.

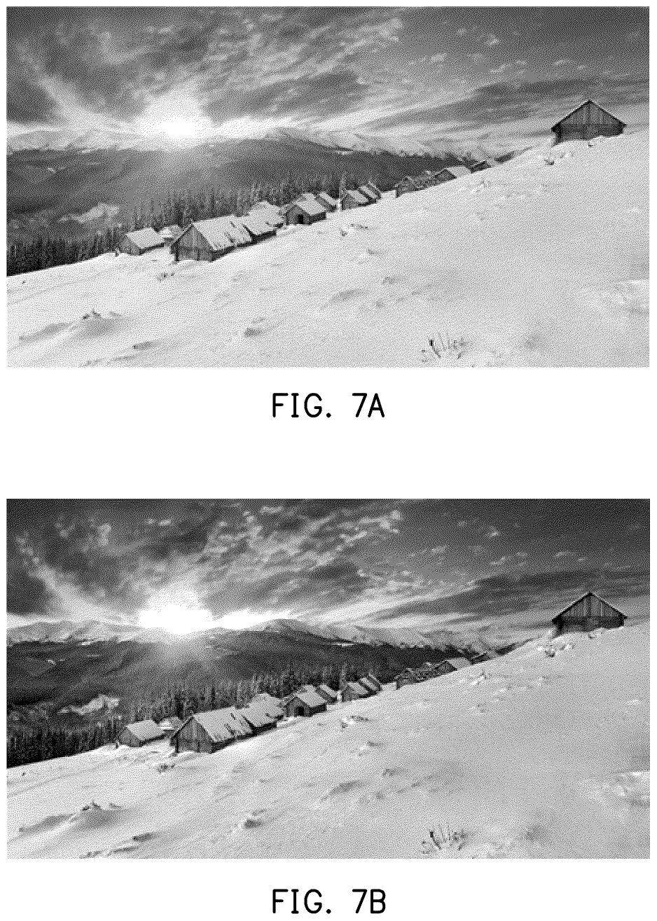

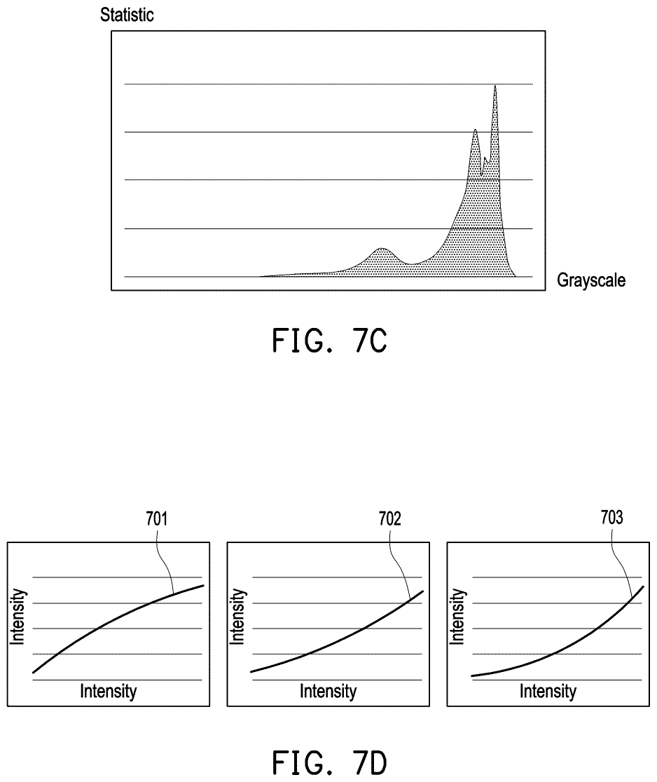

Furthermore, CE processing may be divided into global CE and local CE. In order to save power, the processor circuit 110 may allow a light source brightness to be reduced. Therefore, when the processor circuit 110 performs global CE processing on the image signal S1, the processor circuit 110 may adjust a gamma curve to a bright curve, a normal curve, or a dark curve as shown in FIG. 7D to approach a brightness before the light source reduction or to increase an overall contrast. On the other hand, when the processor circuit 110 performs local CE processing on the image signal S1, the processor circuit 110 allows image details to be sharper and more three-dimensional through neighboring pixel computation or partitioned contrast enhancement. When performing local CE processing on the image signal S1, the processor circuit 110 may divide the screen into multiple regions for contrast enhancement, and calculate one gamma curve for each region.

Therefore, the processor circuit 110 combines global CE and local CE to restore an original brightness of the image, and diverts the user's attention from perceiving the dimmed brightness in a condition where details are enhanced, and may allow the user not to notice the reduced brightness while achieving the power-saving effect.

For LCD apparatus, the processor circuit 110 may adjust a brightness of the LCD apparatus by adjusting a brightness of a light source module. For OLED apparatus, the processor circuit 110 may adjust a brightness of the OLED apparatus by adjusting a light emission time of the OLED.

In the embodiment, the display apparatus 100 has multiple operation modes: a normal mode, a movie mode, an office automation (OA) mode, a vivid mode, a power-saving mode, and a customized mode. The processor circuit 110 may select one from multiple gamma curves (as shown in FIG. 7D) to be adapted to the foregoing operation modes. In addition, when performing global CE processing, local CE processing, and duty cycle gain control, the processor circuit 110 may also select different image processing parameters based on different operation modes.

In the embodiment, a processor or a timing controller may be applied to serve as an example of the processor circuit 110. However, in different types of electronic apparatus, the processor circuit 110 may be other hardware elements with computing and driving functions. In another embodiment, the processor circuit 110 may be designed through hardware description language (HDL) or any other digital circuit design method familiar to persons skilled in the art, and may be a hardware circuit implemented through field programmable gate array (FPGA), complex programmable logic apparatus (CPLD), or application-specific integrated circuit (ASIC). In addition, with reference to common knowledge in the art, sufficient teaching, suggestions, and implementation descriptions for the hardware structure of the processor circuit 110 may be obtained.

In the embodiment, the display panel 120 may be a self-emitting display panel, such as an organic light-emitting diode (OLED) display panel, or a flat or curved thin display apparatus such as a liquid-crystal display (abbreviated as LCD). In other embodiments, the display panel 120 may also be a display panel including micro-LEDs or mini-LEDs. Th disclosure does not limit the type of display panel.

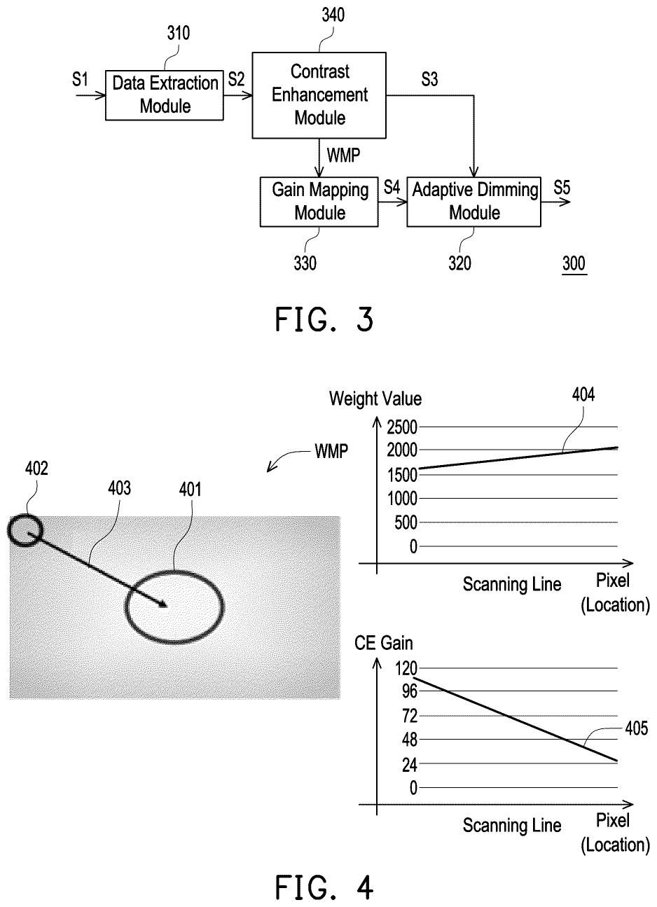

FIG. 3 is a block diagram of an image processing module according to an embodiment of the disclosure. Please refer to FIG. 3. An image processing module 300 of the embodiment includes a data extraction module 310, a contrast enhancement module 320, a gain mapping module 330, and an adaptive dimming module 340.

The data extraction module 310 is configured to receive the image signal S1, and extract an image data from the image signal S1 to recognize a region of interest (ROI) in a screen according to a screen content. For example, the region of interest includes a human portrait. At this time, the data extraction module 310 may, based on an extracted data, perform human skin region detection through calculating an average of luminance (APL) of the screen and counting a pixel histogram. The data extraction module 310 may use an externally defined or controllable hue range to determine which regions might be skin color.

The adaptive dimming module 340 calculates a weight map WMP as shown in FIG. 4 based on a recognition result S2. The gain mapping module 330 maps the weight map WMP to an available range of CE gain. Specifically, in FIG. 4, a region 401 is a region with less brightness reduction. A region 402 is a region with more brightness reduction. A line 404 shows a weight change from the region 402 to the region 401 along a scanning line 403. A line 405 is an available range of CE gain corresponding to the weight change 404. In FIG. 4, the darker the weight map WMP, the stronger the CE gain. The weight change and the gain range shown in FIG. 4 are only for illustrative purposes and are not used to limit the disclosure.

Next, an image signal S3 processed by the adaptive dimming module 340 and a CE gain S4 are input to the contrast enhancement module 320 at the same time. The contrast enhancement module 320 may adjust an intensity of contrast in a partitioned manner on the image signal S3 based on the CE gain S4, thereby outputting an image signal S5 processed by CE. That is to say, the contrast enhancement module 320 may consider the information from the weight map WMP to adjust a final output intensity in a partitioned manner. In this way, the details around the screen may be enhanced.

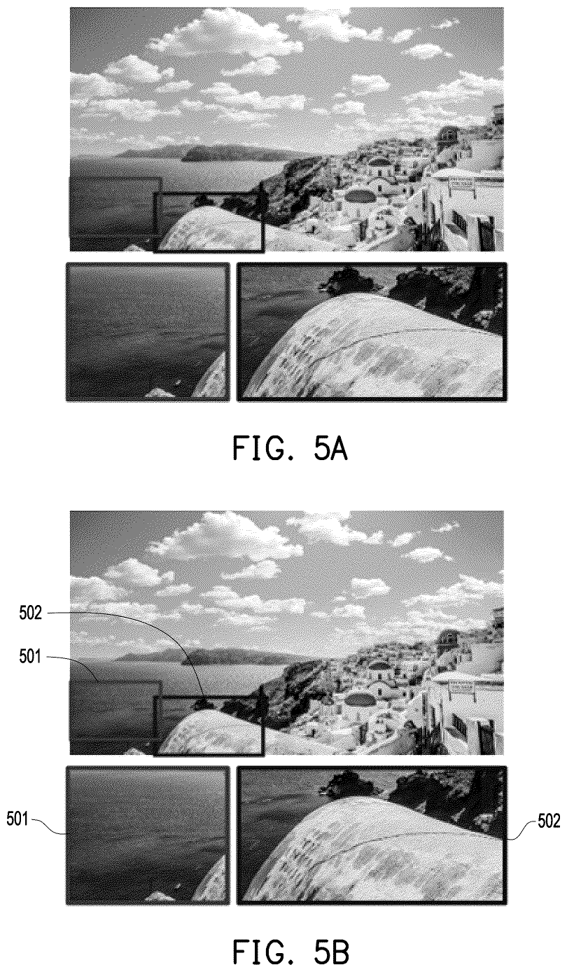

FIG. 5A is an original image before being processed using the image processing module 300. FIG. 5B is an output image after being processed using the image processing module 300. Please refer to FIG. 5A and FIG. 5B. Taking an OLED panel as an example, in terms of power saving, adjusting image brightness through the adaptive dimming module 340 may save about 10% to 20% of electricity. In terms of image quality, adjusting an intensity of contrast in a partitioned manner based on a CE gain through the contrast enhancement module 320 may enhance details in regions 501 and 502 with lower weight values, allowing features in the darker regions 501 and 502 to be more three-dimensional, as shown in FIG. 5B. Therefore, in the embodiment, the image processing module 300 uses an adaptive adjustment function of local contrast, which may allow an image to present more three-dimensional and sharper details in both dark and bright regions.

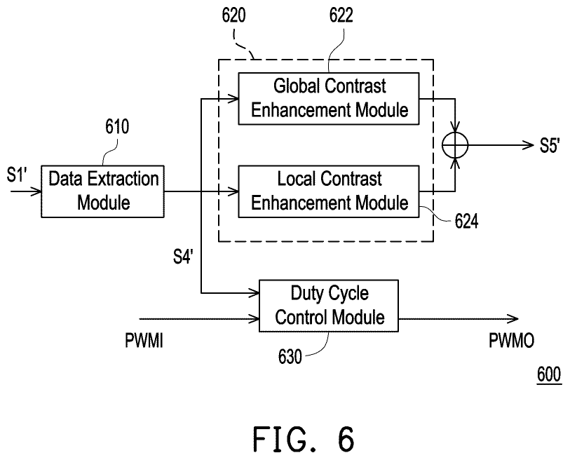

FIG. 6 is a block diagram of an image processing module according to another embodiment of the disclosure. Please refer to FIG. 6. An image processing module 600 of the embodiment includes a data extraction module 610, a contrast enhancement module 620, and a duty cycle control module 630. The contrast enhancement module 620 includes a global contrast enhancement module 622 and a local contrast enhancement module 624.

The data extraction module 610 is configured to receive an image signal S1′, and perform data extraction according to a screen content. An extracted data includes but is not limited to data such as average pixel values, pixel standard deviations, pixel histograms, etc. In addition, the data extraction module 610 may perform computation on the extracted data to generate a duty cycle gain S4′ adapted to the image signal S1′.

The duty cycle control module 630 receives a pulse width modulation signal PWMI, and multiplies the pulse width modulation signal PWMI by the duty cycle gain S4′ to generate a pulse width modulation signal PWMO. The pulse width modulation signal PWMO is configured to drive a light source module (not shown). Therefore, the duty cycle control module 630 may consider the data extracted from the image signal S1′, thereby controlling a brightness of the light source module based on the duty cycle gain S1440 .

On the other hand, the global contrast enhancement module 622 is configured to adjust a global contrast of an image. The global contrast is an overall contrast of all regions of the image. The global contrast enhancement module 622 performs global CE processing on the image signal S1′ based on the screen content to enhance the global contrast and brightness.

The local contrast enhancement module 624 is configured to adjust a local contrast of the image. The local contrast is a contrast of some regions of the image. The local contrast enhancement module 624 performs local CE processing on the image signal S1′ based on the screen content to enhance details and improve a regional contrast.

Therefore, the image processing module 600 combines a processing result of the global contrast enhancement module 622 and the local contrast enhancement module 624 to generate and output an image signal S5′ processed by CE.

FIG. 7A is an original image before being processed using the image processing module 600. FIG. 7B is an output image after being processed using the image processing module 600. FIG. 7C is a pixel histogram obtained by analyzing an original image using the image processing module 600. FIG. 7D is an outline diagram of various gamma curves according to an embodiment of the disclosure.

Please refer to FIG. 7A to FIG. 7D. The image processing module 600 may select one from a bright curve 701, a normal curve 702, and a dark curve 703 in FIG. 7D based on an analysis result of the histogram in FIG. 7C to perform a gamma operation on the original image in FIG. 7A. The pixel histogram is a histogram counted based on brightness information, and calculates a gamma curve adapted to a global image. Therefore, in the embodiment, the image processing module 600 uses the pixel histogram in conjunction with multiple gamma curves to improve a dark region, achieving natural tones and an appropriate overall contrast.

In one embodiment, the data extraction modules 310 and 610, the contrast enhancement modules 320 and 620, the gain mapping module 330, the adaptive dimming module 340, and the duty cycle control module 630 may be implemented through hardware, for example, designed through hardware description language (HDL) or any other digital circuit design method familiar to persons skilled in the art, and may be hardware circuits implemented through field programmable gate array (FPGA), complex programmable logic apparatus (CPLD), or application-specific integrated circuit (ASIC). In addition, with reference to common knowledge in the art, sufficient teaching, suggestions, and implementation descriptions for the hardware structure of each module may be obtained.

In another embodiment, the data extraction modules 310 and 610, the contrast enhancement modules 320 and 620, the gain mapping module 330, the adaptive dimming module 340, and the duty cycle control module 630 may be implemented through software, for example, through storing a computer program in a storage element, commanding the processor circuit 110 to execute image processing functions corresponding to each module after executing the computer program.

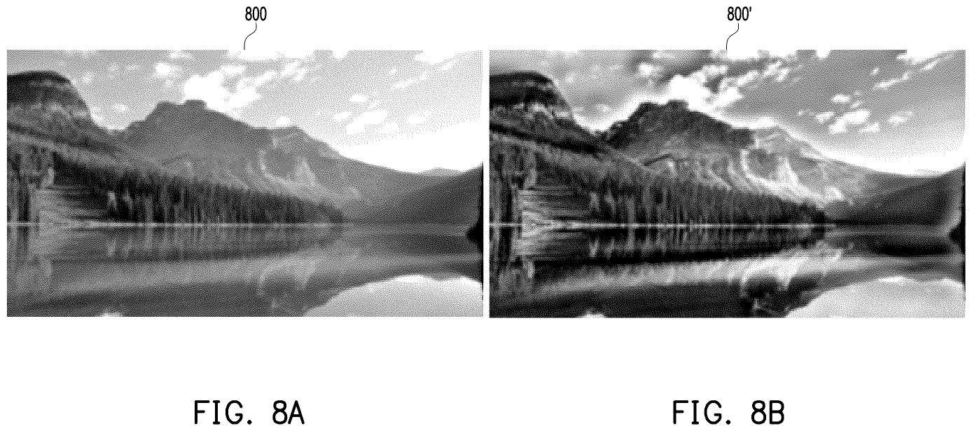

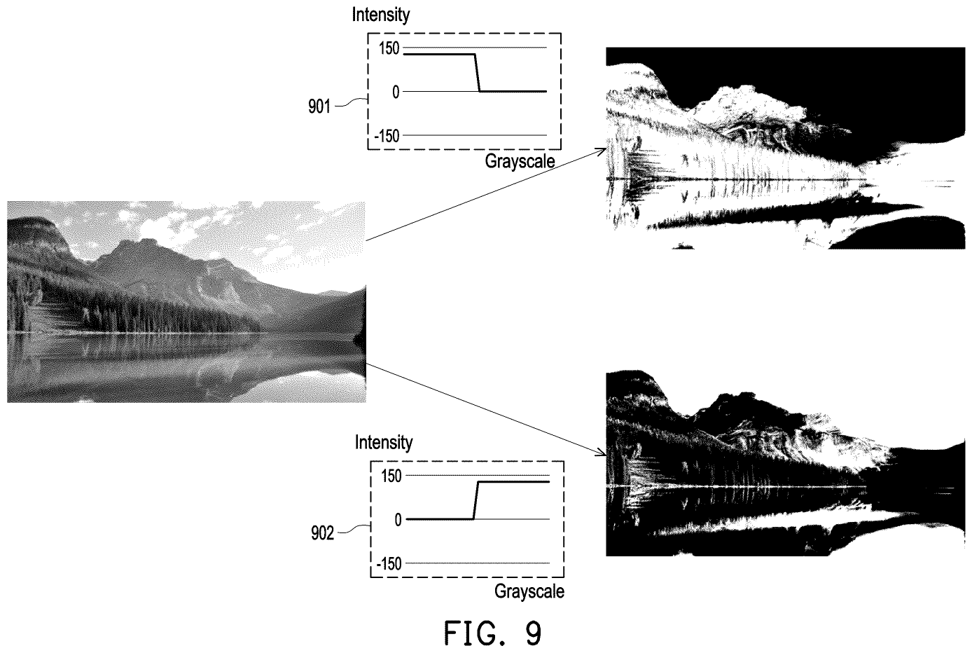

FIG. 8A is an original image before being processed using the image processing module 300. FIG. 8B is an output image after being processed using the image processing module 300. FIG. 9 is an outline diagram of a method of generating a weight map according to an embodiment of the disclosure. Please refer to FIG. 8A to FIG. 9. In the embodiment, the adaptive dimming module 340 may calculate weight maps WMP_D and WMP_B as shown in FIG. 9 according to the recognition result S2. The recognition result S2 input to the adaptive dimming module 340 is, for example, a brightness map 900 corresponding to an original image 800.

The adaptive dimming module 340 generates the weight map WMP_D based on the brightness map 900 and a first weight lookup table 901. The adaptive dimming module 340 gives a higher weight value to a dark region of the original image 800 through the first weight lookup table 901. The adaptive dimming module 340 generates the weight map WMP_B based on the brightness map 900 and a second weight lookup table 902. The adaptive dimming module 340 gives a higher weight value to a bright region of the original image 800 through the second weight lookup table 902.

The adaptive dimming module 340 generates the weight maps WMP_D and WMP_B through this manner, which may allow the gain mapping module 330 and the contrast enhancement module 320, when enhancing a contrast of the original image 800, to allow an output image 800′ to present a more three-dimensional and sharper detail performance regardless in dark regions or bright regions.

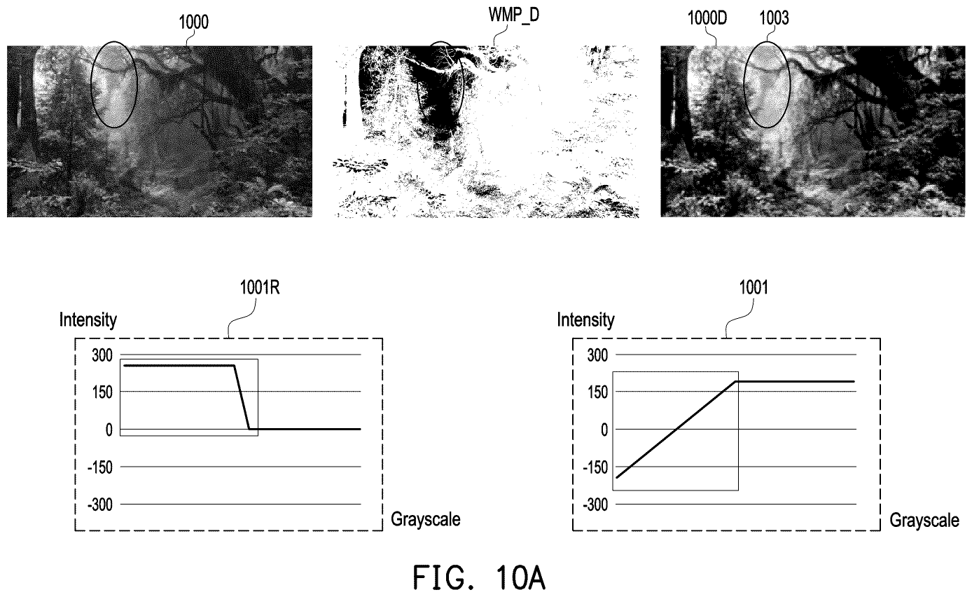

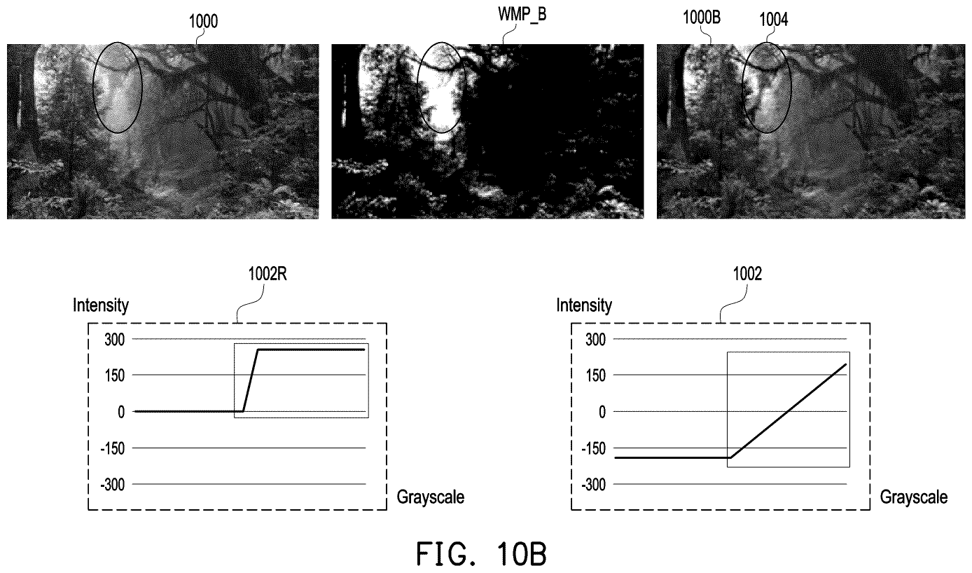

FIG. 10A and FIG. 10B are outline diagrams of the image processing module 300 respectively using different weight maps to perform contrast enhancement on an original image. Please refer to FIG. 10A and FIG. 10B. In FIG. 10A, the image processing module 300 receives an original image 1000, and uses the weight map WMP_D to perform contrast enhancement on the original image 1000, thereby generating an output image 1000D. From the output image 1000D, it can be seen that a contrast has been enhanced in all portions except for a region 1003. In the example, the adaptive dimming module 340 generates the weight map WMP_D based on a brightness map corresponding to the original image 1000 and a first weight lookup table 1001. The first weight lookup table 1001 is a lookup table after a first reference lookup table 1001R has been adjusted. For example, a dark region of the first reference lookup table 1001R may be stretched and a bright region may be raised to obtain the first weight lookup table 1001.

On the other hand, in FIG. 10B, the image processing module 300 receives the original image 1000, and uses the weight map WMP_B to perform contrast enhancement on the original image 1000, thereby generating an output image 1000B. From the output image 1000B, it can be seen that a contrast in a region 1004 has been enhanced. In this example, the adaptive dimming module 340 generates the weight map WMP_B based the brightness map corresponding to the original image 1000 and a second weight lookup table 1002. The second weight lookup table 1002 is a lookup table after a second reference lookup table 1002R has been adjusted. For example, a bright region of the second reference lookup table 1002R may be stretched and a dark region may be reduced to obtain the second weight lookup table 1002.

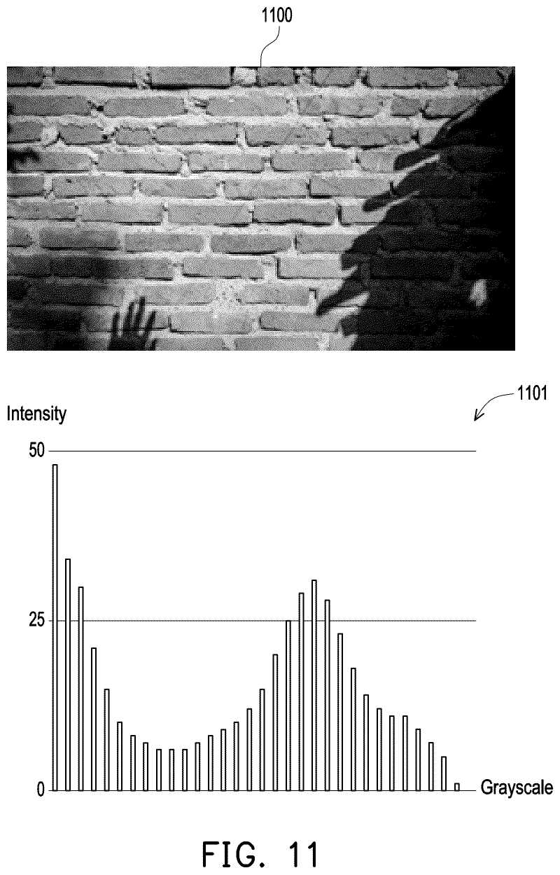

In the embodiment of FIG. 6, the data extraction module 610 may perform data extraction on the image signal S1′ based on a screen content, such as extracting a pixel histogram corresponding to the image signal S1′. FIG. 11 is an outline diagram of a data extraction module performing data extraction in an embodiment of the disclosure. Please refer to FIG. 11. The data extraction module 610, for example, extracts a pixel histogram 1101 of an original image 1100, and provides the pixel histogram 1101 to the global contrast enhancement module 622 and the local contrast enhancement module 624 to serve as a reference basis for selecting a gamma curve.

Before providing to the global contrast enhancement module 622 and the local contrast enhancement module 624, the data extraction module 610 may first perform adjustment on the pixel histogram 1101 to optimize subsequent contrast or brightness processing.

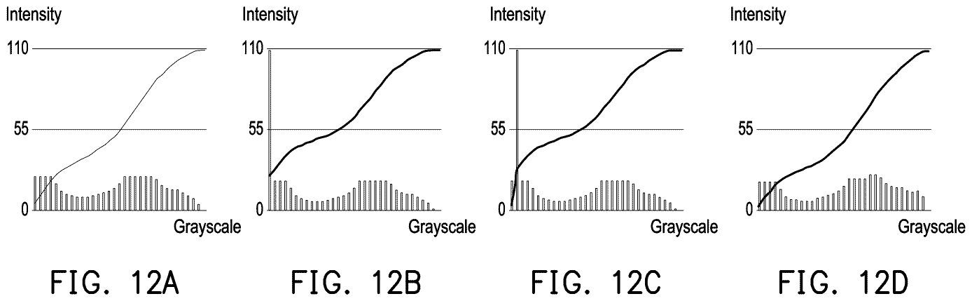

For example, FIG. 12A, FIG. 12B, FIG. 12C and FIG. 12D are respectively outline diagrams of the data extraction module 610 performing adjustment on the pixel histogram 1101. Please refer to FIG. 12A to FIG. 12D. In the embodiment, the data extraction module 610 may set an upper and lower limit values for a statistic of each bin in the pixel histogram 1101 through a register circuit.

In FIG. 12A, the data extraction module 610 evenly allocates statistics exceeding the upper limit to each bin. In FIG. 12B, the data extraction module 610 allocates all statistics exceeding the upper limit to a bin corresponding to grayscale 0. In FIG. 12C, the data extraction module 610 allocates all statistics exceeding the upper limit to a bin corresponding to grayscale 1. In FIG. 12D, the data extraction module 610 allocates statistics exceeding the upper limit to each bin in an increasing manner. Therefore, if certain grayscales need to be stretched, the statistics exceeding the upper limit may be allocated to bins corresponding to those grayscales in a focusing manner. Through the foregoing adjustment manner, a smoother curve corresponding to a respective pixel histogram may be obtained, as shown in FIGS. 12A to 12D, to optimize subsequent contrast or brightness processing.

In the embodiments of FIG. 3 and FIG. 6, the adaptive dimming module 340, the contrast enhancement module 320, the global contrast enhancement module 622 and the local contrast enhancement module 624 may select one from multiple gamma curves to perform brightness or contrast adjustment. In the embodiment, the gamma curves may be pre-adjusted based on an average brightness of an image screen, and then provided to each module to serve as a reference for selection.

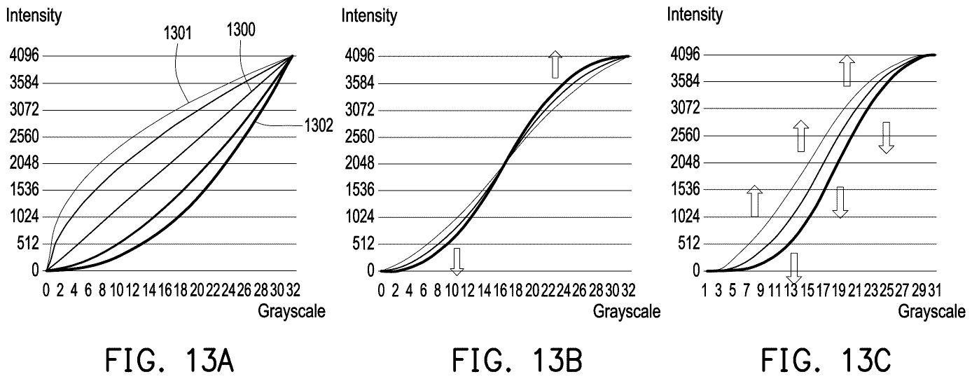

FIG. 13A, FIG. 13B and FIG. 13C are respectively outline diagrams of multiple gamma curves. Please refer to FIG. 13A to FIG. 13C. In FIG. 13A, a gamma curve 1301 with a gamma value γ=0.45 and a gamma curve 1302 with a gamma value γ=2.2 may both be obtained by adjusting a gamma curve 1300 with a gamma value γ=1. An image brightness corresponding to the gamma curve 1301 is brighter. An image brightness corresponding to the gamma curve 1302 is darker.

In FIG. 13B and FIG. 13C, the gamma curves are mixed gamma curves. The multiple gamma curves in FIG. 13A may serve as reference gamma curves to mix and generate multiple mixed gamma curves in FIG. 13B and FIG. 13C. For example, the characteristics of suppressing a dark region and enhancing a bright region may be used to mix and generate the multiple gamma curves in FIG. 13B and FIG. 13C to enhance a global contrast and brightness.

Therefore, the adaptive dimming module 340, the contrast enhancement module 320, the global contrast enhancement module 622 and the local contrast enhancement module 624 may select one from the gamma curves in FIG. 13B or FIG. 13C to perform brightness or contrast adjustment based on an average brightness of an image screen. In this way, even though an original image is darker, each module may adaptively enhance a contrast and increase or reduce a brightness.

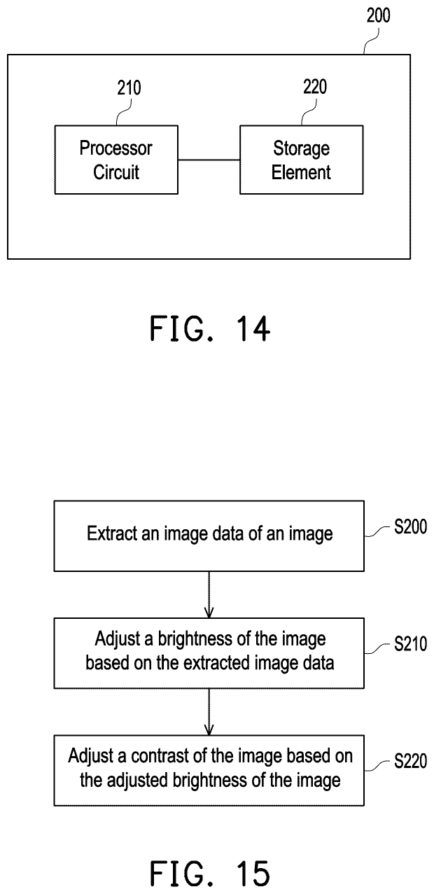

FIG. 14 is a block diagram of an electronic apparatus according to an embodiment of the disclosure. FIG. 15 is a flowchart of steps of an image processing method according to an embodiment of the disclosure. Please refer to FIG. 14 and FIG. 15. An electronic apparatus 200 includes a processor circuit 210 and a storage element 220. In one embodiment, the electronic apparatus 200 is, for example, a computer, and the storage element 220 is, for example, a computer readable recording media, including a computer program that commands the computer to execute the image processing method of FIG. 15 after executing the computer program.

Specifically, in step S200, the processor circuit 210 extracts an image data of an input image. In step S210, the processor circuit 210 adjusts a brightness of the image based on the extracted image data. In step S220, the processor circuit 210 adjusts a contrast of the image based on the adjusted brightness of the image.

In one embodiment, the processor circuit 210 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA) or other similar elements or a combination of the foregoing elements.

In one embodiment, the storage element 220 is configured to store various software, data, and various code needed for running the electronic apparatus 200. The storage element 220 is, for example, any type of fixed or movable random access memory (RAM), read-only memory (ROM), flash memory, hard disk drive (HDD), solid state drive (SSD) or similar elements or a combination of the foregoing elements, and configured to store multiple modules or various applications that may be executed by the processor circuit 210. In one embodiment, the storage element 220 may further include a database.

In addition, for the image processing method of the embodiment, sufficient teaching, suggestions, and implementation descriptions may be obtained from the descriptions of the embodiments in FIG. 1 to FIG. 13C, so no further elaboration is needed.

In summary, in the embodiments of the disclosure, the processor circuit performs partitioned processing on the image through the information of the weight map, enhancing the details in regions with reduced brightness. For a brighter region, since the magnitude of brightness reduction is not significant, the processor circuit may give a preset local CE intensity. For a darker region, since the magnitude of brightness reduction is greater, the processor circuit may increase the intensity of local CE to reserve and enhance the details in the region. In this way, the processor circuit may enhance the image quality of the display apparatus in a power saving condition.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An image processing method, adapted to adjust a contrast and a brightness of an image, the image processing method comprising:
extracting an image data of the image;
adjusting the brightness of the image based on the extracted image data; and
adjusting the contrast of the image based on the adjusted brightness of the image.

2. The image processing method according to claim 1, wherein the step of extracting the image data of the image comprises:
recognizing a region of interest in an image screen based on the image data.

3. The image processing method according to claim 2, wherein the step of recognizing the region of interest in the image screen based on the image data comprises:
calculating an average brightness of the image screen, and counting a pixel histogram to perform a human skin region detection.

4. The image processing method according to claim 2, wherein the step of adjusting the brightness of the image based on the extracted image data comprises:
adjusting brightnesses of a first region and a second region in the image based on a recognition result, wherein the brightness of the first region is greater than the brightness of the second region; and
calculating a weight map corresponding to the image, wherein the weight map comprises a weight value corresponding to the first region and a weight value corresponding to the second region, and the weight value of the first region is greater than the weight value of the second region.

5. The image processing method according to claim 4, wherein the step of adjusting the contrast of the image based on the adjusted brightness of the image comprises:
adjusting the contrast of the image based on the weight map, wherein a contrast of the second region is greater than a contrast of the first region.

6. The image processing method according to claim 5, wherein the step of adjusting the contrast of the image based on the weight map comprises:
calculating a contrast gain based on the weight map, wherein a contrast gain of the second region is greater than a contrast gain of the first region; and
adjusting the contrasts of the first region and the second region based on the contrast gain.

7. The image processing method according to claim 4, wherein the step of calculating the weight map corresponding to the image comprises:
generating the weight map based on a brightness map corresponding to the image and a weight lookup table.

8. The image processing method according to claim 7, wherein the step of calculating the weight map corresponding to the image further comprises:
adjusting the weight lookup table based on a reference lookup table.

9. The image processing method according to claim 1, wherein the step of extracting the image data of the image comprises:
extracting a pixel histogram corresponding to an image screen based on the image data, and generating a duty cycle gain based on the pixel histogram.

10. The image processing method according to claim 9, wherein the step of adjusting the brightness of the image based on the extracted image data comprises:
generating a pulse width modulation signal based on the duty cycle gain, and driving a light source module based on the pulse width modulation signal to adjust the brightness of the image.

11. The image processing method according to claim 9, wherein the step of adjusting the contrast of the image based on the adjusted brightness of the image comprises:
adjusting a global contrast of the image, wherein the global contrast is an overall contrast of all regions of the image; and
adjusting a local contrast of the image, wherein the local contrast is a contrast of some regions of the image.

12. The image processing method according to claim 9, wherein the step of extracting the pixel histogram corresponding to the image screen based on the image data, and generating the duty cycle gain based on the pixel histogram comprises:
setting an upper limit value and a lower limit value for statistics of the pixel histogram, wherein the pixel histogram comprises a plurality of bins; and
allocating statistics exceeding the upper limit value among the plurality of bins to other bins in the pixel histogram.

13. The image processing method according to claim 1, wherein the step of adjusting the brightness of the image based on the extracted image data comprises:
selecting one gamma curve from a plurality of gamma curves; and
adjusting the brightness of the image based on the selected gamma curve.

14. The image processing method according to claim 13, wherein the step of adjusting the brightness of the image based on the extracted image data further comprises:
mixing and generating the plurality of gamma curves based on a plurality of reference gamma curves.

15. A computer readable recording media, comprising a computer program, commanding a computer to execute an image processing method after executing the computer program, and the image processing method comprising:
extracting an image data of an image;
adjusting a brightness of the image based on the extracted image data; and
adjusting a contrast of the image based on the adjusted brightness of the image.

16. An electronic apparatus, comprising a processor and a storage element, the storage element storing a computer program, commanding the processor to execute an image processing method after executing the computer program, and the image processing method comprising:
extracting an image data of an image;
adjusting a brightness of the image based on the extracted image data; and
adjusting a contrast of the image based on the adjusted brightness of the image.

17. The electronic apparatus according to claim 16, wherein the step of extracting the image data of the image comprises:
recognizing a region of interest in an image screen based on the image data.

18. The electronic apparatus according to claim 16, wherein the step of extracting the image data of the image comprises:
extracting a pixel histogram corresponding to an image screen based on the image data, and generating a duty cycle gain based on the pixel histogram.

19. The electronic apparatus according to claim 16, wherein the step of adjusting the brightness of the image based on the extracted image data comprises:
selecting one gamma curve from a plurality of gamma curves; and
adjusting the brightness of the image based on the selected gamma curve.

20. The electronic apparatus according to claim 19, wherein the step of adjusting the brightness of the image based on the extracted image data further comprises:
mixing and generating the plurality of gamma curves based on a plurality of reference gamma curves.
